(19) United States
(12) Patent Application Publication
(10) Pub. No.: US 2003/0038556 A1
(43) Pub. Date: Feb. 27, 2003

(54) Variable reluctance motor

(76) Inventors: Koenraad Alexander Gieskes, Binghamton, NY (US); Stanislaw Wladyslaw Janisiewicz, Endwell, NY (US); Darrin Michael Weiss, Vestal, NY (US); Andrew Zalesski, Apalachin, NY (US)

Correspondence Address: William C. Rowland, BURNS, DOANE, SWECKER & MATHIS, L.L.P., P.O. Box 1404, Alexandria, VA, 22313-1404, US

(21) Appl. No.: 10/178,525

(22) Filed: Jun. 25, 2002

Related U.S. Application Data
(63) Continuation-in-part of application No. 09/929,438, filed on Aug. 14, 2001.
Application No. 09/929,438 is a continuation-in-part of application No. 09/820,766, filed on Mar. 30, 2001.
Application No. 09/820,766 is a continuation of application No. 09/538,898, filed on Mar. 30, 2000, now abandoned.
(60) Provisional application No. 60/300,728, filed on Jun. 25, 2001.

(51) Int. Cl. H02K 1/00; H02K 3/00; H02K 7/06

(52) U.S. Cl. 310/179; 310/81

(57) ABSTRACT

A variable reluctance motor includes a phase assembly (102, 801) having more than one phase unit (121, 122, 123, 821, 822, 823), each of said phase units comprising at least one module (131, 132, 831, 832), each said module comprising an electrically conductive coil (140, 840) wound around the module in one or more windings, each of said phase units being magnetically isolated from every other phase unit, each of said phase units defining a flux path. The motor further includes a ferromagnetic core (101, 810) within the flux path.

### CROSS-REFERENCE TO RELATED APPLICATIONS

The present application is a continuation-in-part of U.S. application Ser. No. 09/929,438, filed Aug. 14, 2001, which is a continuation-in-part of U.S. application Ser. No. 09/820,766, filed Mar. 30, 2001, which is a continuation of U.S. application Ser. No. 09/538,898, filed Mar. 30, 2000, now abandoned, and the present application also claims the benefit of U.S. provisional Application No. 60/300,728. The contents of application Ser. Nos. 09/820,766; 09/929,438; and 60/300,728 are hereby incorporated herein by reference.

### BACKGROUND OF THE INVENTION

1. Field of the Invention

The present invention relates to a variable reluctance motor. More particularly, the present invention relates to a variable reluctance motor in which a number of modules are arranged and adjusted for efficiently providing optimum power with limited heat generation and/or hysteresis loss.

2. Description of Related Art

Variable reluctance motors are used as direct drive motors for machines that perform repeated applications requiring a high degree of accuracy. These motors can include phase assemblies and ferromagnetic cores, sometimes referred to as stators, that control the movement of tools such as robotic arms and placement heads along the X-axis and the Y-axis. During the operation of certain machines, each phase assembly and its core move relative to each other via electromagnetic flux. The flux is generated in phase units of each phase assembly in response to an electrical current flowing through coils wrapped about portions of the phase units. The relative movement between each phase assembly and its core causes the related robotic arm or placement head to move from a first position to a second position. However, this position-to-position movement must be completed with a high degree of precision and at a high velocity under varying load conditions.

In conventional variable reluctance motors, the relative movement between each phase assembly and its stator is controlled by a program that selectively applies electrical current to the coils of each assembly's phase units in a particular sequence. Controllers for delivering electrical current to each phase unit and causing translational motion of the phase assembly are well known in the art. One such controller is disclosed in U.S. Pat. No. 5,621,294 to Bessette et al.

In variable reluctance motors, such as that described in U.S. Pat. No. 3,867,676 to Chai et al., the windings and stator are each formed by securing a stack of members, such as laminations, together along adjoining faces. The windings are formed on stacked core members that include a plurality of legs that are connected to each other along a common plate that extends the length of the motor. Each leg and stator includes flux delivering teeth that extend along a longitudinal or toothed surface. The teeth of each leg are intended to deliver the electromagnetic flux at predetermined locations along the surface of each leg that faces in the direction of the stator. Adjacent teeth are separated by grooves along the toothed surface of the stator and the legs. The connection between these legs permits the electromagnetic flux generated at one leg to leak along the length of the motor to an adjacent leg.

When the flux leaks along the length of the motor, the accuracy of the motor movements is compromised and the cores may move further along the stator than intended. This additional, unintended movement can cause damage to the element being picked up or positioned by the robotic arm or placement head of the machine. For example, if additional, unintended movement of a phase assembly occurs along its elongated stator in a circuit board assembly machine, the components being positioned can be delivered to the wrong location on the board and possibly damaged if they are forced into a location without a proper hole pattern. As a consequence, the operation of the circuit board can be so adversely effected that the board may not function properly.

Other conventional variable reluctance motors have attempted to overcome the problems associated with the Chai et al. motor. One such attempt is disclosed in U.S. Pat. No. 5,015,903 to Hancock et al. The disclosed motor includes a rack that moves relative to a stator having unevenly spaced U-shaped cores. In this motor, a coil is wound around each parallel extending leg of the U-shaped cores. Each wrapped coil extends away from its leg in the direction of an adjacent core. Each wrapped coil generates an electromagnetic flux when it receives a current. In order to prevent flux from leaking between adjacent U-shaped cores, the cores are spaced a significant distance away from each other by a low reluctance material such as plastic. As a result, the flux generated in the coil encircling each leg is confined to its respective U-shaped core. While this arrangement may prevent flux from leaking between adjacent cores, it significantly increases the size of the motor. Adjacent cores must be separated by a distance that includes two components: (1) the distance that adjacent cores need to be spaced so that the generated fluxes do not interfere with each other and (2) the distance that each coil extends away from its core in the direction of an adjacent core. The location and positioning of these cores are predefined and fixed based on the number of phases required to satisfy the power requirements of the motor. As a result, the position of the cores and the number of cores in each of the above-discussed motors cannot be adjusted in order to change the power produced by their respective motors. Even though this motor is disclosed as being uncoupled, it is not modular.

U.S. Pat. No. 6,078,114 to Bessette et al. also discloses a variable reluctance linear motor. Like other prior art variable reluctance motors, the motor disclosed by Bessette et al. includes a stator and a phase assembly that move relative to each other. The phase assembly includes a plurality of assemblies that have E-shaped cores (E-cores). Like the above-discussed motors, the electromagnetic flux generating coils are wrapped about the legs of the E-cores. Hence, the cores of this motor must also be sufficiently spaced from each other so that the flux from one coil does not interfere with that of the coil on an adjacent core. Additionally, support bearings are provided in order to maintain the gap between the stator and the E-cores. The support bearings contact and travel along the side surfaces of the stator as the assemblies move relative to the stator in order to maintain the E-cores at a constant distance from the stator. Each support bearing is secured to a shaft that is received in a hole at the end of a cantilevered spring. This arrangement requires that the support bearings accept the force of the stator during the operation of the motor. This can lead to premature failure of the bearings. Also, the relatively large spans between the bearings and the spring-loaded suspension of the E-core assemblies in the motor housing allow flexing of the E-core assemblies in response to the force of the stator. This can result in substantial changes in the air gap between the stator and the E-cores and constant fluctuation of the attraction force between them, thereby causing vibration control problems and excessive noise. As a consequence, the motor will not operate smoothly and quietly.

In all of the above-discussed motors, the flux of adjacent cores flows in the same direction. This causes the flux direction to reverse within the stator at a high frequency, thereby causing unwanted hysteresis, rippled movement and unnecessarily inefficient motor operation.

### SUMMARY

In one embodiment of the present invention, a variable reluctance motor comprises a phase assembly comprising more than one phase unit, each of said phase units comprising at least one module, each said module comprising an electrically conductive coil wound around the module in one or more windings, each of said phase units being magnetically isolated from every other phase unit, each of said phase units defining a flux path; and a ferromagnetic core within said flux path.

Another embodiment of the present invention includes a variable reluctance motor, comprising a plurality of phase units and a ferromagnetic core, each of the phase units comprises a C-shaped core having two legs and a center portion, a coil around the center portion, and a plurality of teeth at the ends of the legs, wherein the teeth face the ferromagnetic core and each of the phase units are substantially magnetically isolated from each other.

Another embodiment of the present invention relates to a method of controlling a variable reluctance motor having at least first and second adjacent phase units, wherein the first phase unit includes at least one leg through which a first magnetic flux passes during operation of the motor and the second phase unit includes at least one leg through which a second magnetic flux passes during operation of the motor, and the at least one leg of the first phase unit is adjacent to the at least one leg of the second phase unit. The method comprises supplying electric current to a first electrically conductive coil in the first phase unit of the motor and thereby inducing an electromagnetic flux in the first phase unit in a first direction; and supplying electric current to a second electrically conductive coil in the second phase unit of the motor and thereby inducing an electromagnetic flux in the second phase unit in a second direction; said phase units being arranged such that the magnetic flux passes through the leg of the first phase unit in a same direction as the magnetic flux passes through the adjacent leg of the second phase unit.

Yet another embodiment of the present invention relates to a module for a variable reluctance motor. The module comprises a C-shaped core having a center portion and two legs extending away from the center portion in a first direction; and a fan shaped guide in the center portion for a plurality of windings, the guide having a first section facing the first direction and a second section facing away from the first direction, the first section being narrower than the second section so that the windings in the first section are closer together than the windings in the second section.

### BRIEF DESCRIPTION OF THE DRAWINGS

FIG. 1 is a schematic view of a modular variable reluctance motor including a phase assembly according to the present invention.

FIG. 2 is a partial exploded isometric view of the phase assembly shown in FIG. 1.

FIG. 3 is a cross sectional view of a phase unit of FIG. 1, with a stator interposed between phase modules.

FIG. 4 is a perspective view of a module of a phase unit of the motor according to the present invention.

FIG. 5 is a view of a bobbin used in the module of FIG. 4.

FIG. 6 is a perspectivec view of the stator shown in FIG. 1.

FIG. 7A is a diagram of flux paths through three phase units and a stator according to an embodiment of the present invention.

FIG. 7B is a diagram of flux paths through three phase units and a stator according to an alternative embodiment of the present invention.

FIG. 8 is a schematic view of a rotary embodiment of the present invention.

FIG. 9 is a schematic diagram of a core used in the embodiment of FIG. 8.

FIG. 10 is a schematic cut-away view of a portion of the rotary motor system embodiment of FIG. 8.

FIG. 11 is a perspective view of the rotary motor system embodiment of FIG. 8.

FIG. 12 is a perspective view of a module of the rotary motor system embodiment of FIG. 8.

FIG. 13 is a plan view of the module of FIG. 12.

FIG. 14 is an exploded view of an embodiment of rotary motor system of FIG. 8.

### DETAILED DESCRIPTION OF THE PREFERRED EMBODIMENTS

FIG. 1 illustrates a linear variable reluctance motor 100 that comprises a stator 101 and at least one phase assembly 102 according to an embodiment of the present invention. The motor operates with improved accuracy relative to the prior art. Additionally, motor 100 does not experience the levels of hysteresis loss and heat buildup found in prior art motors.

In one embodiment, the linear variable reluctance motor 100 is used with a machine that receives and positions components in a substrate. Such machines are commonly referred to as “pick and place machines” and examples are disclosed in U.S. Pat. Nos. 5,852,869 and 5,649,356. Although the present invention is described with respect to a pick and place machine, its use is not limited only to this machine. Instead, it can be incorporated into any machine that requires high velocity movements that must be completed with a high degree of accuracy.

Additionally, the present invention is not limited to linear variable reluctance motors. Instead, the present invention is applicable to rotary as well as linear variable reluctance motors. In another embodiment, the motor operates as a stepper motor.

In one embodiment of variable reluctance linear motor 100, a phase assembly 102 is configured to move along the longitudinal axis of the stator 101 while the position of the stator 101 is fixed against movement, as discussed below and illustrated in FIG. 1. In an alternative embodiment, the stator 101 slides within the phase assembly 102 while the position of the phase assembly 102 is fixed against movement.

Phase assembly 102 moves relative to the stator 101 in response to the application of a generated force, such as an electromagnetic flux, as illustrated in FIG. 1. In this embodiment, the stator 101 is fixed in position and the phase assembly 102 moves along the length of the stator 101 during the operation of the motor 100. According to one embodiment of the motor 100, when motion is required in more than one plane, a plurality of phase assemblies and stators are employed. For example, a first phase assembly moves relative to a first stator in a direction parallel to the X-axis and a second phase assembly moves relative to a second stator in a direction that extends parallel to the Y-axis. Translational movement of the phase assembly 102 along its stator 101 is controlled by selectively applying electrical current to one or more phase units. One example of a controller suitable for use in the present invention is described in U.S. Pat. No. 5,621,294.

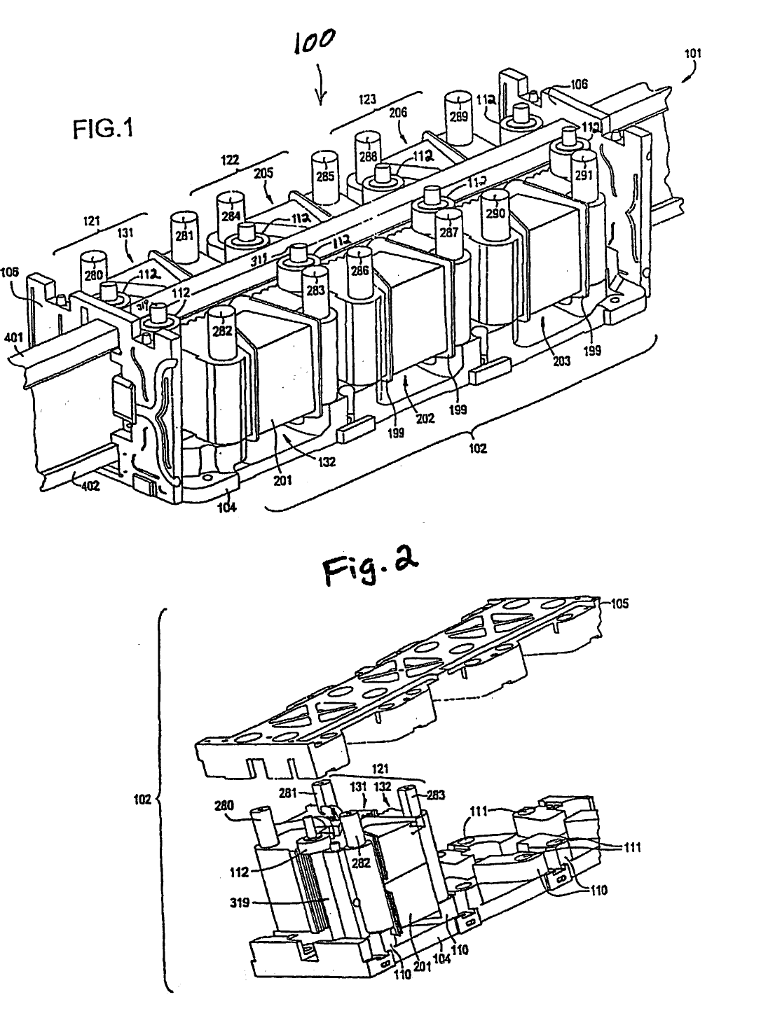

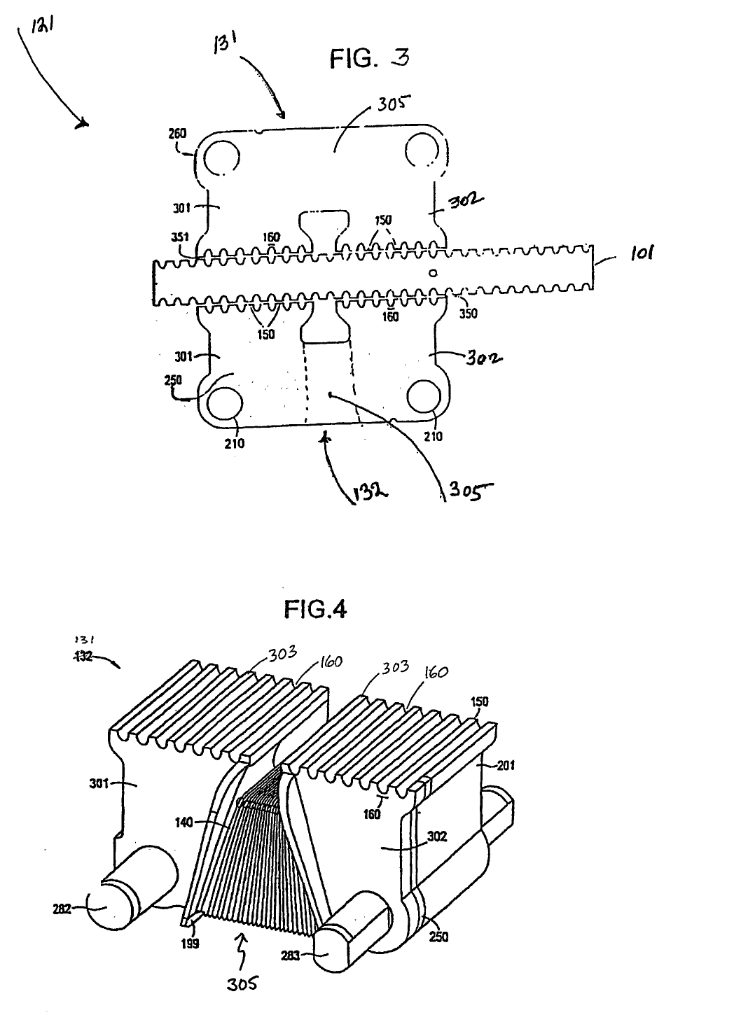

As shown in FIGS. 1 and 2, each phase assembly 102 comprises stator guide bearings 112, housing plates 104 and 105, pre-formed bosses 110 with wells 111, and end pieces 106. Each phase assembly 102 also comprises at least one phase unit 121-123. In alternative embodiments, the motor 100 includes between two and seven phase units depending on the desired number of phases, and upon the accuracy and power requirements of the pick and place machine in which motor 100 is employed.

In one embodiment of the invention, phase units 121-123 are substantially identical units. The number (n) of phase units comprising a given phase assembly is chosen according to the power requirements of motor 100. The greater the required power the more phase units are installed in a phase assembly. Because the phase units are preferably substantially identical, assembly of a variety of phase assemblies having different power capabilities can be achieved by utilizing different numbers of substantially identical parts. This simplifies the manufacture of the phase assembly and achieves significant cost savings.

In this embodiment of the invention, phase units 121-123 are modular phase units. As defined herein, “modular” means comprising removable and replaceable sections (modules). In one embodiment, the phase units 121-123 are also interchangeable. Each phase unit 121-123 comprises two opposing paired modules 131, 132; 205, 202; 206, 203, respectively.

The modules of each phase unit face each other from opposite sides of the stator 101. The modules are substantially identical, spaced apart and secured to base housing plate 104 and top housing plate 105 in mirror image positions. No matter the shape of the modules, they are separated from each other by the stator 101 and air gaps 350, 351. For example, as shown in FIGS. 1 and 3, phase unit 121 comprises modules 131 and 132 that face each other across stator 101. The same is true of phase unit 122 that comprises modules 205 and 202, and phase unit 123 that comprises modules 206 and 203.

One module will be described in detail for ease of explanation. An example module 131 is shown in FIG. 4. The description of this one module 131 is equally applicable to the other modules of the present invention. The module 131 comprises a core 201 and a pair of shafts 282 and 283, as shown in FIGS. 1 and 4.

Core 201 comprises a stack of laminations 250. In one embodiment of the invention the core 201 is formed of silicon iron. Other embodiments include cores formed of other ferromagnetic materials known to those in the motor arts. The module 131 includes a bobbin 199 that is formed of a nonconductive material, as discussed below. Alternative embodiments, however, do not include a bobbin. Module 131 further includes a wire coil 140 comprising at least one winding positioned around the core 201. In one embodiment, the wire coil 140 includes about 100 windings.

The core 201 is substantially C-shaped, and the laminations 250 are referred to herein as C-core laminations 250. As shown in FIGS. 3 and 4 each core 201 includes a pair of legs 301, 302 that extend from a center section 305 in the direction of the stator 101 when the motor 100 is assembled. Each leg 301, 302 comprises a plurality of teeth 150. Each tooth 150 includes an outer longitudinal flux surface 303. The surfaces 303 are separated from each other by corresponding grooves 160. The grooves 160 not only separate adjacent surfaces 303, but the shape of the grooves 160 also defines the shape of each tooth 150. In an embodiment comprising C-core laminations 250, when core laminations 250 are secured together, core 201 includes rows of teeth 150 separated by rows of grooves 160 as shown in FIG. 3. The core 201 in each module is fabricated using a ferromagnetic material that has a high saturation level at low current levels. In one embodiment, the material is silicon iron. Another suitable material is a cobalt-iron alloy, for example, HIPERCO® available from CARPENTER®.

Adjacent stacked core laminations 250 are fixed together to prevent their relative movement. Various methods for fixing the stacked laminations 250 together include using a clamp, welding with a laser, staking or bonding with a non-conductive epoxy. Other methods for securing the laminations 250 together can also be employed. In one embodiment, each stacked C-core lamination 250 is bonded to an adjacent lamination 250 by a non-conducting bonding epoxy that is applied by submerging each lamination 250 of the stack in a bath of this epoxy in an impregnation fixture. In one embodiment, QT-30GF/000 from M. A. HANNA ENGINEERED MATERIALS is a sulfonated polysulfone polymer glass fiber reinforced material that is used as the insulating, non-conductive adhesive material. In another embodiment, EP19 HT-FL(SP) 85-15 Flexiblize Mix, available from Master Bond® Polymer System, is an acceptable epoxy for securing adjacent laminations 250 together.

In a method of securing the C-core laminations 250 together in the stack by vacuum impregnation, the C-core laminations 250 are stacked together in a conventional stacking fixture and covered with silicon caps. After the C-core laminations 250 have been stacked together, their height is confirmed for accuracy. The C-core laminations 250 are then submerged in a bonding epoxy (adhesive) within an impregnation fixture. The fixture cover is then closed and the vacuum turned on. The vacuum is maintained for about 20 minutes after the vacuum pressure level reaches about 25 inches of mercury. After approximately 20 minutes has expired, the C-core laminations 250 are removed from the impregnation fixture and set in a dripping fixture. The adhesive is allowed to drip for about one hour. Any excess adhesive is cleaned from the stack and the bobbin 199 is installed. The silicon caps are also removed and the C-core laminations 250 are clamped in a curing fixture. The curing fixture is placed in an oven, preheated to about 300 degrees, then is ramped to about 375 degrees for about 1-hour and soaked at about 375 degrees for about 9-hours. Cooling occurs in an oven at approximately 100 degrees. After the cooling has been completed, the C-core 201 is removed from the curing fixture and excess adhesive is removed.

The number of C-core laminations 250 that are secured together to form the stack can be varied in order to vary stack thickness. In one embodiment of the present invention, a module of the phase assemblies that moves relative to the stator 101 includes about one hundred-ninety to about two hundred-fifty secured laminations 250. In another embodiment, the core 201 includes about two hundred-fourteen secured C-core laminations 250. Each of these laminations 250 is between about ten and twenty millimeters thick. A preferred thickness for each lamination 250 is about fourteen millimeters. In one embodiment, a stack of C-core laminations 250 in a module moving along the x-axis has two-thirds the total number of C-core laminations 250 as a y-axis module. The greater the stack height, the more force produced by the module 131.

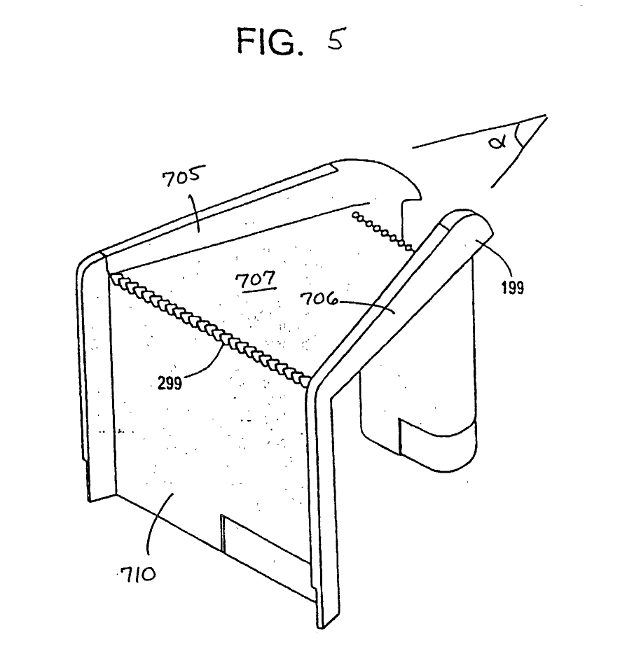

Wire coil 140 is formed by winding a wire at least one time, i.e., at least one turn, around the bobbin 199 at the center of module 131. Wire coil 140 is guided by the bobbin 199, which fits securely around the center of core 201 as seen in FIG. 4. In one embodiment, the bobbin 199, also depicted in FIG. 5, includes grooves 299 on its outer surface for receiving the coil 140. The wound coil 140 is positioned by bobbin 199 in a generally fan shape. This fan shape is advantageous in directing the flow of electromagnetic flux through the legs 301 and 302 of the module and toward the teeth 150. The fan shape also spreads the coil windings over the largest possible surface area so that the number of winding layers is minimal. For example, in one embodiment of the invention the fan shape results in the formation of only a few, e.g., one or two, windings on an outer surface 710 of the bobbin 199, as shown in FIG. 5. The large surface area of the bobbin 199 and the small number of windings on the surface of the bobbin 199 contribute to the quick dissipation of the heat generated by the coil 140 when compared to the prior art as discussed below. Other embodiments, however, include more coil layers yet still permit heat to be quickly dissipated. Additionally, by positioning the coil 140 between legs 301 and 302, the generated electromagnetic flux flows in the direction of the teeth 150 and is concentrated there. The modules of the preferred embodiment, as shown in the figures, are capable of being positioned closer together than the units of the prior art, thereby reducing the overall size of the motor 100 compared to prior art motors. Similarly, the preferred embodiment permits more modules to be positioned in the same amount of space than does the prior art.

As illustrated in FIGS. 4 and 5, the bobbin 199 has a fan-like shape and is positioned about the center 305 of the core 201 of C-core laminations 250. From the view shown in these figures, the bobbin 199 has a substantially V-shape and includes first and second sidewalls 705, 706 respectively spaced on opposite sides of a main body portion 707 that includes the plurality of coil organizing grooves 299. The sidewalls 705, 706 form an angle a, shown in FIG. 5, that allows the coil 140 to spread out when it is constrained by the bobbin 199. In a first embodiment, the angle α, created by the sidewalls 705 and 706, is between about 0 and 80 degrees. In another embodiment, the angle α is about 30 degrees. In one embodiment, each sidewall 705, 706 increases in height as it extends toward the stator 101 in order to provide support and guidance to the overlapping portions of the coil 140 at the second surface 720 while the coil 140 is being wrapped during the construction of the motor 100. Moreover, in an embodiment, each sidewall 705, 706 includes a hook member for anchoring the bobbin within the C-shaped opening. Alternatively, the bobbin is secured to the core 201 using well known adhesives.

The fan shape of bobbin 199 and the resulting distribution pattern of the coil 140 also provide better spatial distribution of the individual windings of the coil 140 compared to the prior art. The individual windings wrapped around bobbin 199 are spread out over surface 710 so that there are fewer windings per inch than the prior art. By providing fewer windings per inch, especially along surface 710, the preferred embodiment provides for a more efficient dissipation of the heat generated by electrical current flowing through coil 140. Thus, ambient air cooling is often sufficient for cooling motor 100, and the need for forced air cooling systems is obviated. Of course, in alternative embodiments, other suitable arrangements are employed for winding the coil wire in a fan shaped manner.

The bobbin 199 is formed of a conventional electromagnetic-insulating material. In the embodiment, the bobbin 199 is made of non-ferromagnetic and non-conductive materials such as plastics. In another embodiment, the material used to form the bobbin 199 includes liquid crystal polymers. No matter the material used, the bobbin 199 in one embodiment is formed separate of the core 201 and positioned over the core 201 during the assembly of the motor. In another embodiment, the bobbin 199 is molded directly on and over the core 201. Additionally, in another embodiment, known electromagnetic insulating materials are positioned between the coil 140 and the core 201 in place of the bobbin 199.

As seen in FIG. 1, the plates 104, 105 positioned on either side of the phase modules are located in planes that extend parallel to each other and comprise a part of the housing of the phase assembly 102. End pieces 106, as shown in FIG. 1, are removably attached to the base housing plate 104 and the top housing plate 105. In the embodiment, the end pieces 106 may include oil-saturated felt wipers (not shown) that lubricate rails 401, 402 of the stator for low friction rolling engagement with stator guide bearings 112. In the embodiment, the end pieces 106 support a motion brake sensor of the type described in U.S. Pat. No. 5,828,195 entitled “Electronic Brake for a Variable Reluctance Motor”, the subject matter of which is hereby incorporated herein by reference.

As shown in FIG. 2, the housing plates 104 and 105 are provided with pre-formed bosses 110 having integrally formed wells 111 for receiving and securely retaining shafts 280-291 extending through and outwardly from the cores 201 of C-core laminations 250 of each module. The shafts 280-291 are securely and rigidly received within the bosses 110 so that the shafts 280-291 are not moveable relative to housing plates 104, 105. The shafts 280-291 receive the force applied to their respective core 201 by the stator 101 and, as a result of their rigid, non-flexible connection to the housing plates 104, 105, transfer substantially all of the forces applied to the core 201 by the stator 101 to the housing plates 104, 105. By reducing the forces absorbed by the core 201 and its associated bearings 112, the life of the motor is increased relative to prior art motors.

In the embodiment, each module is retained by press fitting its respective pair of the shafts 280-291 into the wells 111 of the base plate 104 and the top plate 105. The shafts 280-291 are made of non-ferromagnetic material. Shafts 280-291 are securely fitted through holes 210 in laminations 250 and are used to position the module 131 in the wells 111 of the housing plates 104, 105 of the phase assembly 102. One of the shafts of each pair (for example 282, 283) of the shafts 280-291 includes at least one flat edge surface for aiding in the easy and reliable positioning and orientation of the modules within their respective phase assembly by this one shaft only being able to be received in a specific one of the wells 111 for each phase unit. As is clear from the above discussions, the base and the top plates 104, 105 are configured to provide fixed locations for removable placement of the modules and the stator guide bearings 112. The removable aspect of the motor 100 includes the plates 104, 105 being designed so that modules can be repeatedly added to the phase assembly 102 or removed from the phase assembly 102 to adjust the characteristics of the motor 100. This provides an operator with the ability to change the number of modules within the phase assembly 102 without having to change the structure of either plate 104, 105.

The press fit relationship of the shafts 280-291 within each plate 104, 105 makes the assembly of the phase assembly 102 fast, reliable and easy. The press fit improves the tolerance of the phase assembly housing by reducing the accuracy requirements of the cooperating shaft and housing plate. Additionally, the press fit relationship allows for an easy reduction or increase in the number of phase units and modules within a phase assembly 102. For example, in an embodiment comprising three phase units, one of the three phase units can be removed by the steps of removing the top housing plate 105 and withdrawing the shafts of the eliminated phase unit from the base housing plate 104. After the eliminated phase unit has been taken out of the phase assembly 102, the housing of the phase assembly 102 is reconstructed by positioning top housing plate 105 over the remaining shafts 280-291 of the remaining phase units and securely fitting the housing plates 104, 105 together. Conversely, to add a phase unit to a phase assembly 102, the housing plates 104 and 105 are separated and the shafts of the new phase unit are positioned within corresponding wells 111 in base housing plate 104. After the inserted phase unit is secured to the base housing plate 104, the top housing plate 105 is positioned over it so that the shafts of the new phase unit are also received in their respective wells 111. The housing plates 104, 105 are then secured together against relative movement by being press fitted onto the shafts of all of the phase units under pressure. Alternatively, conventional ways of securing the plates 104, 105 together can be used. These conventional ways include, but are not limited to, removable fasteners. Although the above procedure describes that the top housing plate 105 is removed first, this is for purpose of explanation only. The above procedure can be performed by first separating the base housing plate 104 from the phase units.

Instead of removing an entire phase unit, one embodiment of the present invention provides for one module of a particular phase unit or all the phase units to be removed by the procedure discussed above. Further, it is also possible for the phase assembly 102 to be expanded beyond the capacity of its original housing plates 104, 105. In this instance, new plates 104, 105 having more bosses 110 and wells 111 for receiving the shafts of the additional phase units will be positioned on the shafts of the existing phase units and then the additional phase units can be inserted as discussed above.

The stator 101, like the core 201, can be formed from a plurality of plates (laminations) fixed together to prevent relative movement of the stator plates and to ensure structural integrity. The stator 101 can be formed in accordance with conventional practice and of the same material as the laminations 250. Below and above the stack of stator plates, rails 401 and 402 are attached in alignment with the outer edges of the stack of stator plates.

As shown in FIG. 1, the stator 101 is slidably coupled to its corresponding phase assembly 102 by at least one set of stator guide bearings 112. In the illustrated embodiment, each phase unit 121-123 has associated therewith eight stator guide bearings 112, four associated with each module. The guide bearings 112 rotate as the stator 101 and phase assembly 102 move relative to each other during the operation of the motor 100. The stator guide bearings 112 roll in contact with the flat, smooth, metallic surface of the rails 401 and 402 as the phase unit assembly 102 moves longitudinally along the stator 101. The stator guide bearings 112 are interposed between the stator 101 and the modules to prevent contact between the stator 101 and the modules.

As seen in FIG. 3, air gaps 351, 350 separate the stator 101 from the modules in a phase unit. The size of the air gaps 351, 350 on one side of the stator 101 is preferably the same as on the other side of the stator 101. In other words, the stator 101 is preferably centered exactly between opposing modules of a phase unit. However, in practice, the stator 101 is rarely initially positioned so that the size of the gaps 351, 350 is the same. As a result, one embodiment of the present invention includes a positioning system that is used to adjust the distance between each module and the stator 101. In the positioning system, the guide bearings 112 are held on compliant shafts 319 so that a space between opposing bearings 112 that receives stator 101 is slightly smaller than the width of the stator 101.

A preload on the shafts 319 causes a mechanical force that is applied to the stator 101 through bearings 112. The shafts 319 are preloaded such that pressure is applied against stator 101. In one embodiment, a preload of about 100 lbs. of force per bearing 112 is applied against the stator 101 when the stator 101 is positioned between the bearings 112. The pressure maintains the position of the stator 101 and overcomes manufacturing variations that may exist in the modules and the stator 101. The pressure per bearing can vary by about 25 percent depending on the size and speed of the motor.

As a result of the preload, the bearings 112 are positioned flush against the inserted stator 101 so that they contact and apply a locating pressure to the first and second rails 401, 402 of the stator 101, as shown in FIG. 1, in response to flexion of shaft 319. The stator guide bearings 112 then adjust the location of the stator 101 so that same sized air gaps 350, 351, shown in FIG. 3, are formed on either side of the stator 101. It has been found that changing this distance so that each of the paired modules is spaced equidistant from the stator 101 creates symmetry about the stator 101 and reduces the amount of vibration and acoustic noise created during the operation of the variable reluctance motor.

The shafts 319 are secured to the base and top housing plates 104, 105 so that each guide bearing 112 is securely held against movement in a direction parallel to the length of shaft 319 even when the shaft 319 is flexed. The shafts 319 are formed of a non-ferromagnetic material that permits them to bend in a direction that extends at an angle to their length. For example, the shafts 319 can deflect outwardly so that they apply pressure against the bearings 112. One such material used for shafts 319 is a stainless steel in the 300 stainless steel material series.

In one embodiment, each guide bearing 112 includes a conventional ball bearing. Other known types of bearings and bearing surfaces that permit movement of the stator 101 relative to the phase assembly 102 can also be used. Examples include bearings having fluid between inner and outer bearing surfaces. Additional examples include bearings that include dry metal lubricants on at least one of their bearing surfaces.

The amount of electromagnetic force generated by phase assembly 102 is adjustable in several ways. A first way includes increasing or decreasing the number of laminations 250 in core 201. A second way includes adjusting the number of windings of the coil 140 about the bobbin 100. A third way includes adjusting the amount of current through the wire coil 140. Fourth and fifth ways include adjusting the number of modules per phase unit and the number of phase units in the phase assembly 102, respectively. Any combination of these ways can also be used to adjust the force of the motor 100.

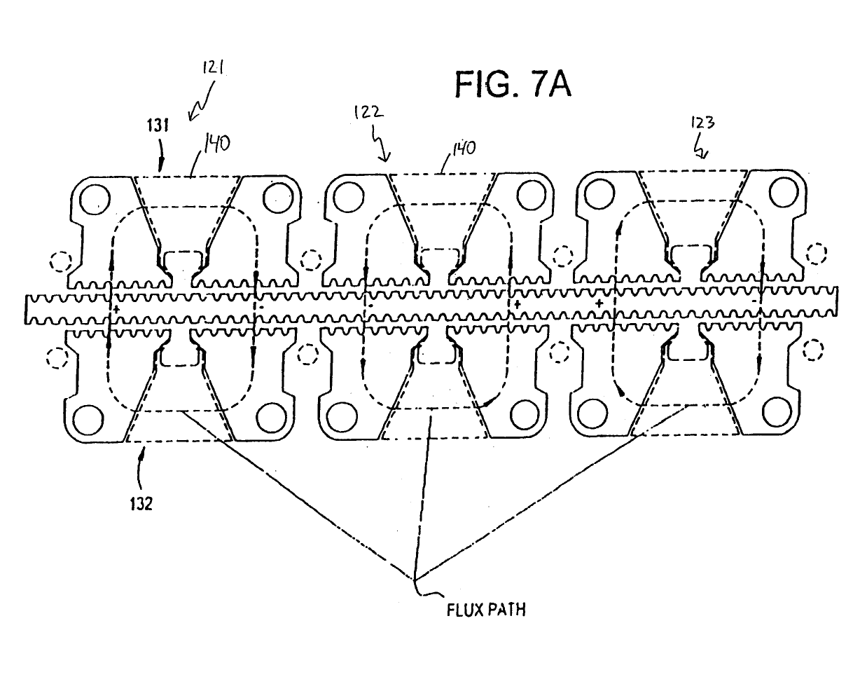

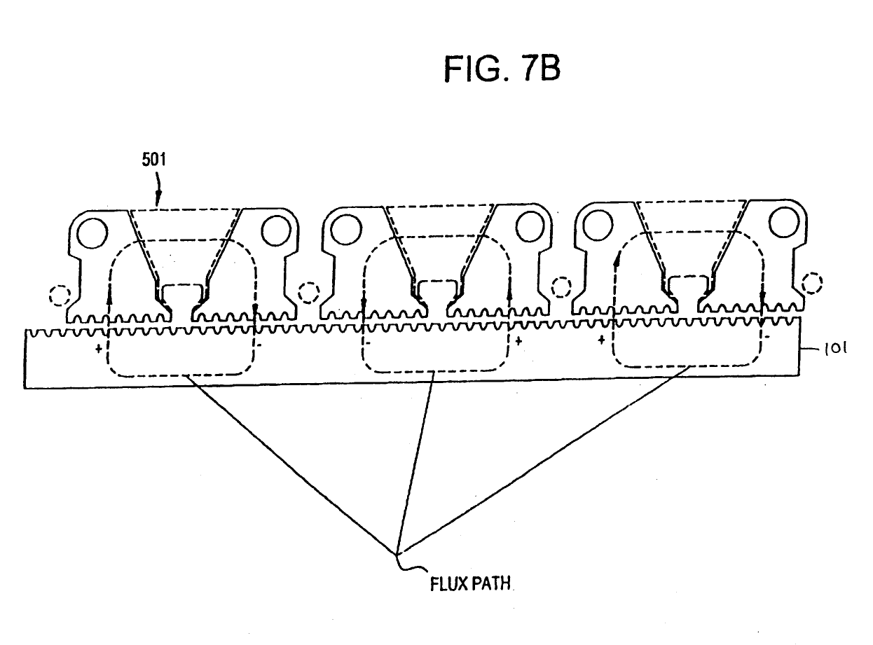

Each phase unit comprises at least one of the modules described above. In one embodiment, phase assembly 102 comprises at least one unpaired module 501 as shown in FIG. 7B. In this embodiment, the at least one unpaired module 501 is positioned adjacent to the stator 101. In an alternative embodiment, phase assembly 102 comprises paired modules 131, 132 as shown in FIG. 7A. In the alternative embodiment, the two paired modules 131, 132 that form a phase unit are placed on opposite sides of the stator 101 as described herein.

Referring now to the exemplary embodiment shown in FIG. 7A, electromagnetic flux flows in only one direction (i.e., either clockwise or counterclockwise) within a given phase unit in conjunction with stator 101. As discussed above, the adjacent phase units are electrically and electromagnetically isolated from each other and are uncoupled along the same side of the stator 101. The electrical current through coil 140 of any given module may at any given translational position be adjusted such as by being turned on or off. By maintaining a constant electromagnetic flux direction within a module, the modular phase variable reluctance motor of the present invention reduces hysteresis losses in the stator that would be caused by reversing electromagnetic flux direction.

In an alternative embodiment using unpaired modules, as shown in FIG. 7B, the flux flows through each individual module 501 and stator 101 as a complete circuit.

Hysteresis losses are proportional to the frequency of directional change of the electromagnetic flux. Therefore, in one embodiment of the invention, the flux direction in adjacent phase units 121-123 is alternated. For example, as shown in FIG. 7A, the flux for phase unit 121 is in a clockwise direction, the flux for phase unit 122 is in a counter-clockwise direction, and the flux for phase unit 123 is in a clockwise direction. In another embodiment, the flux for phase unit 121 is in a counter-clockwise direction, the flux for phase unit 122 is in a clockwise direction and the flux for phase unit 123 is in a counterclockwise direction. In still further embodiments, phase units 121-123 may respectively have fluxes in an A-A-B pattern, an A-B-B pattern or any other alternating or partially alternating A B pattern, wherein A is a first direction and B is a second opposite direction.

Any combination of flux directions may be used for any number of phases in a motor. Where there are only two phases in a motor, the first phase unit has a first flux direction while the second phase unit may have a second opposite flux direction. Likewise, such opposite flux directions may be implemented where a motor has more than three phases. For instance, where a motor has four phases, the flux direction for each respective phase unit is A-B-A-B, A-A-B-B, A-A-A-B, A-B-B-B or any other alternating or partially alternating A B pattern. Independent control of the flux direction for each phase unit, such as phase units 121-123, is made easier where the phase units are each electromagnetically insulated or isolated from one another, as is the case with motor 100.

As used herein, ferromagnetic material means any material possessing or exhibiting ferromagnetic properties, as that term is commonly understood, sufficient to make the material suitable for use in the present invention as described herein. The designations top and base are for reference purposes only and are not intended to be limiting on the position of the housing plates 104, 105 or the orientation of the phase assembly 102.

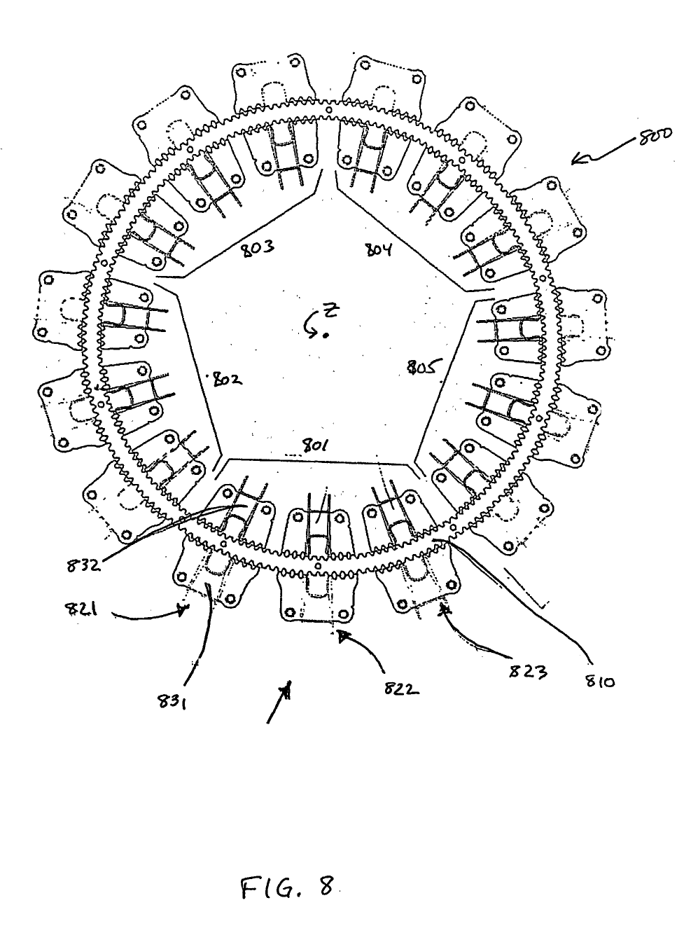

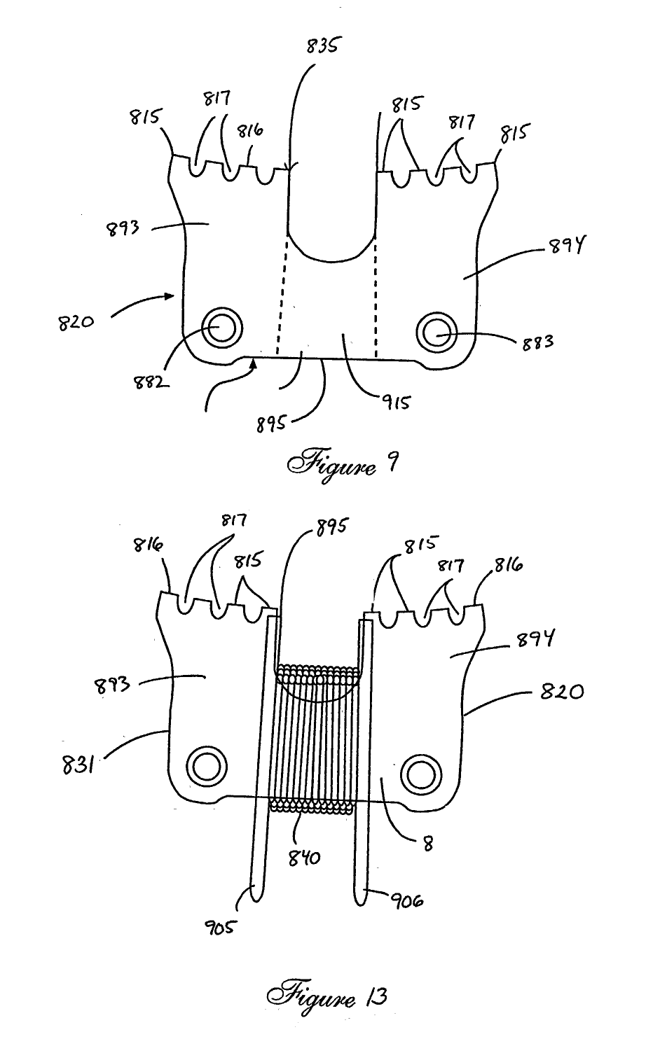

FIG. 8 illustrates another embodiment of the present invention in the form of a variable reluctance rotary motor system 800 that comprises five phase assemblies 801, 802, 803, 804 and 805. The motor system 800 does not experience the levels of hysteresis loss and heat buildup found in prior art rotary motor systems. In one embodiment, rotary variable reluctance motor system 800 is used with a machine that receives and positions components in a substrate. Such machines are commonly referred to as “pick and place machines” and examples are disclosed in U.S. Pat. Nos. 5,852,869 and 5,649,356. Although the preferred embodiment is described with respect to a pick and place machine, its use is not limited only to this machine. Instead, it can be incorporated into any machine that requires high velocity, rotary movements, even those that must be completed with a high degree of accuracy. One example application is motor vehicle drive systems, including direct drive systems. The rotary movement includes embodiments requiring complete rotations and others requiring partial rotations or both. The preferred embodiment is applicable to rotary variable reluctance motors that operate as servo motors so that any desired position can be achieved. In another embodiment, the motor operates as a stepper motor.

While the embodiment of the motor system 800 illustrated in FIG. 8 includes five phase assemblies, alternative embodiments may comprise more or less than five motors. Each phase assembly of the motor system 800 comprises between two and seven phase units depending on the desired number of phases, and upon the accuracy and power requirements of the machine in which motor system 800 is employed.

In one embodiment, each phase assembly 801-805 comprises three phase units 821, 822, 823 corresponding to phases A, B and C, respectively, of motor assembly 800. However, alternative embodiments of each phase assembly may include one or two phase units. Additional alternative embodiments may include more than three phase units. The particular number of phase units for each phase assembly depends on the desired number of phases for each motor.

In one embodiment of the invention, phase units 821-823 are substantially identical units. The number (n) of phase units comprising a given phase assembly is chosen according to the power requirements of motor system 800. The greater the required power, the more phase units installed in each phase assmelby. Because the phase units 821-823 are substantially identical, assembly of a variety of phase assemblies having different power capabilities can be achieved by utilizing different numbers of substantially identical parts. This simplifies the manufacture of the phase assemblies and achieves significant cost savings in the production of the motor assembly 800.

In an alternative embodiment of the invention, phase units 821-823 are modular phase units. As defined herein, “modular” means comprising removable and replaceable sections (modules). In one embodiment, the phase units 821-823 are also interchangeable. Each phase unit 821-823 comprises two opposing paired modules 831 and 832, as illustrated in FIG. 8.

In a first embodiment shown in FIG. 8, each phase unit 821-823 includes an outer phase-module 831 and an inner phase module 832. Phase modules 831 and 832 are positioned on opposite sides of a substantially circular rotor 810 in a pattern that follows the circumference of the rotor 810. In another embodiment, each phase unit 821-823 includes only one phase module. In one such embodiment, each phase unit 821-823 includes only the outer phase module 831. In an alternative embodiment, phase units 821-823 include only the inner phase module 832. Regardless of the embodiment, each phase module 831, 832 comprises a core as discussed below. FIG. 9 illustrates a preferred embodiment of a core 820 for the outer phase module 831.

As shown in FIG. 8, the phase assemblies 801-805 and their respective phase units are arranged in a substantially circular configuration about an axis Z. In one embodiment, the distance between adjacent phase units 821-823 within each phase assembly is less than the distance between the outer phase units 821, 823 of adjacent phase assemblies 801-805. In another embodiment, illustrated in FIG. 8, the distance between the phase unit 821-823 within a phase assembly is the same as the distance between the phase units 821, 823 of adjacent phase assemblies. Additionally, the distance between the outer phase modules 831 of each phase assembly may be greater than the distance between the inner phase modules 832 for the same phase assembly.

As shown in FIG. 8, the substantially circular rotor 810 is positioned between the phase modules 831, 832 of the phase units 821-823 and moves in a circular path about the axis Z relative to the phase modules 831, 832 and their phase units 821-823 as the phase units 821-823 are energized. As used herein, the phrase “circular path” includes the path of travel experienced during circular movement, semi-circular movement, arcuate movement, semi-arcuate movement and other types of movement that occur during rotational and/or oscillating motion.

In the embodiment of the variable reluctance motor system 800 illustrated in FIG. 8, the phase units 821-823 of each phase assembly 801-805 are fixed against rotation. In this embodiment, the phase assemblies 801-805 are securely fixed to a non-rotating back plate 839 using elongated shafts 882, 883 and conventional epoxies as discussed below. The rotor 810, on the other hand, is configured to rotate between the phase modules 831, 832 in a complete revolution or partial revolution. In an alternative embodiment the rotor 810 is fixed against movement while the phase units 821-823 rotate along the inner and outer circumferences of the rotor 810. As used herein, the term “configured” means operatively arranged so as to perform a specified function.

The rotor 810 moves relative to the phase units 821-823 in response to the application of a generated magnetomotive force. In this embodiment, the rotor 810 rotates between the modules 831, 832 of the phase units 821-823 during the operation of the motor system 800. According to an embodiment of the motor system 800, when the rotor 810 moves, a turret 850 also moves in the same direction as the rotor 810. Rotational movement of the rotor 810 relative to the phase units 821-823 of any one of the phase assemblies 801-805 is controlled by selectively applying electrical current to one or more phase units 821-823 of each phase assemblies 801-805. One example of a controller suitable for use in the present invention is described in U.S. Pat. No. 5,621,294, which is hereby incorporated herein by reference.

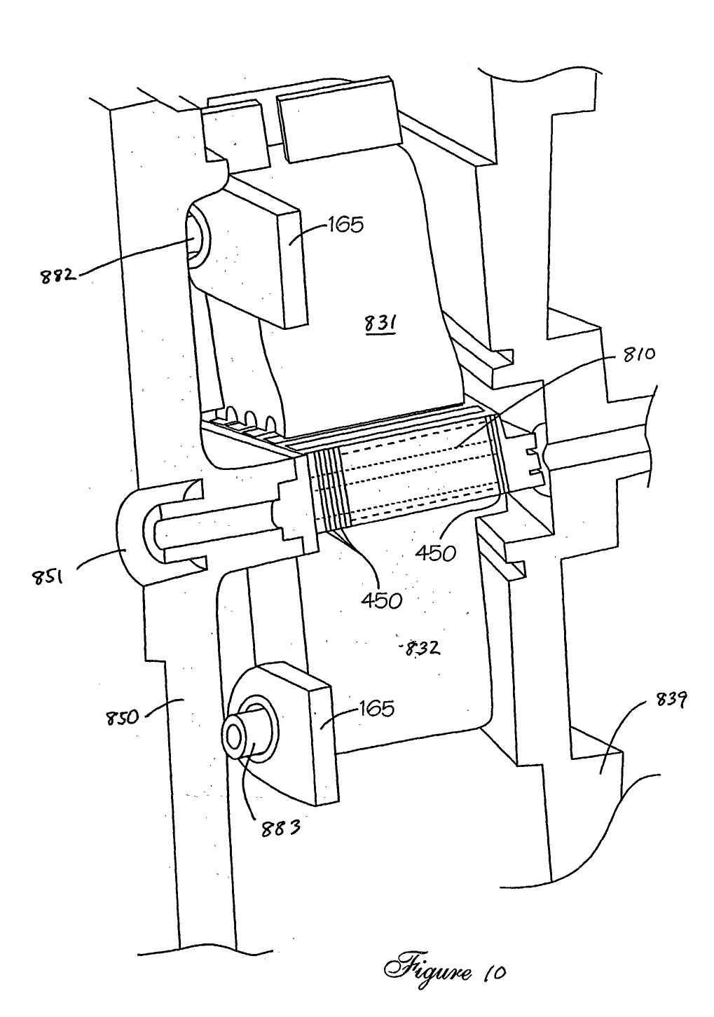

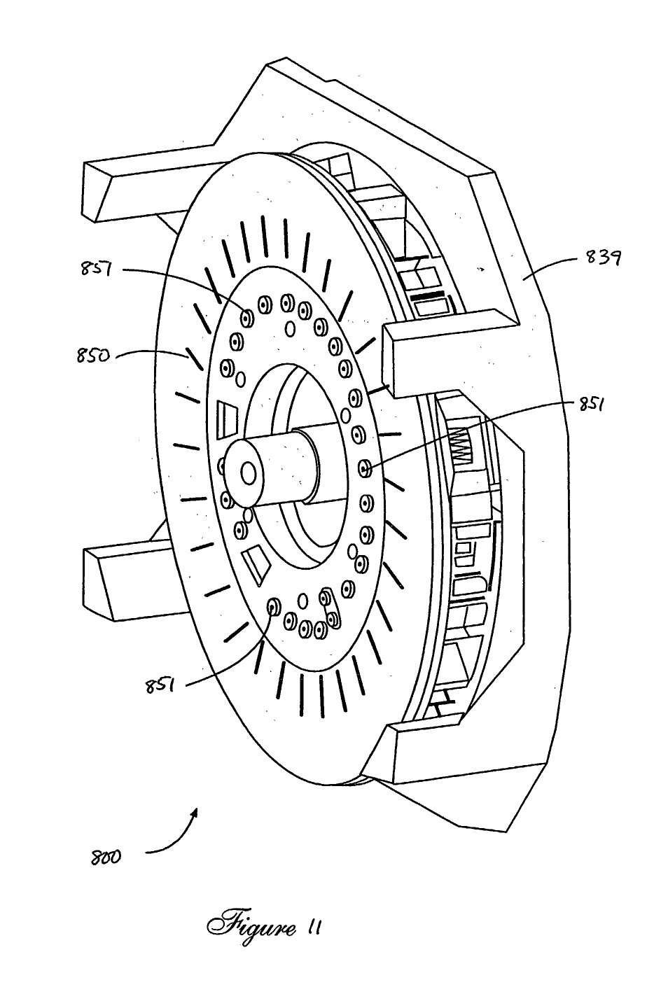

In one embodiment, as shown in FIGS. 10 and 11, the rotor 810 is secured to the turret 850 by a plurality of fastening members 851 such that motion of the rotor 810 results in motion of the turret 850. The turret 850 rotates about and is supported by a bearing that forms a part of back plate 839. In an alternative embodiment, the bearing is secured to the back plate 839.

As shown in FIGS. 8 and 10, the modules 831 and 832 of each phase unit 821-823 secured to the back plate 839 face each other from opposite sides of the rotor 810. The modules 831 and 832 are similar, but they differ in their size and their rotor facing profile. The rotor facing profile of each module 831, 832, as used herein, relates to the curved shape of the face 835 of each module 831, 832 that is proximate to, and coextensive with, the rotor 810. The spacing between each module 831, 832 is the same from phase unit 821-823 to phase unit 821-823 and from phase assembly to phase assembly 801-805. Preferably, the spacing between each phase module 831, 832 and the rotor 810 is substantially the same from phase unit 821-823 to phase unit 821-823 and from phase assembly 801-805 to phase assembly 801-805. This consistent spacing between the modules 831, 832 of the phase units 821-823 and the rotor 810 provides the motor system 810 with reduced noise during operation when compared to conventional rotary motors.

While the motor assembly 800 includes embodiments with one module and embodiments with a plurality of modules, for ease of explanation the specifics of only one phase assembly 801 will be discussed. Additionally, only one phase unit 821 with phase modules 831, 832 on opposite sides of the rotor 810 will be explained. The description of this phase assembly 801, phase unit 821 and the modules 831, 832 is equally applicable to the other phase assembly 802-805 and phase units 822, 823 of the motor system 800.

As mentioned above, motor 800 includes at least one phase unit 821 and phase modules 831, 832. Each phase module 831 and 832 comprises a core 820. Outer phase module 831 also includes a concave rotor face 835 that follows the outer circumference of the rotor 810 as shown in FIG. 9. Similarly, the inner phase module 832 has a convex rotor face that follows the inner circumference of the rotor 810, as shown in FIG. 8. In one embodiment, modules 831 and 832 further comprise a pair of the shafts 882 and 883 that extend through passages in the cores 820 for securing the cores 820 to holes in the back plate 839, as illustrated in FIG. 10.

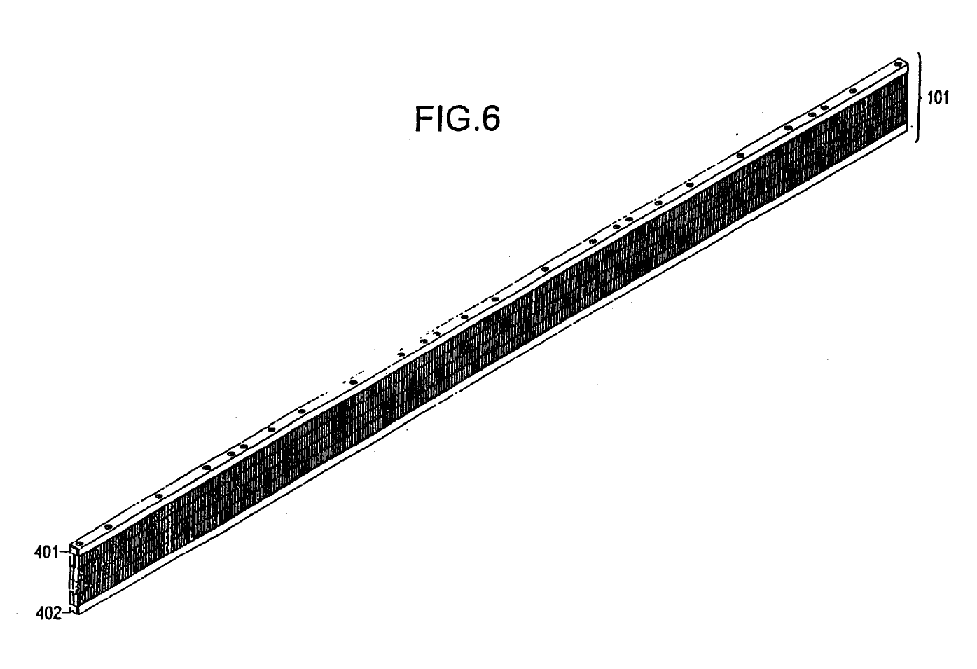

As with the preferred embodiments illustrated in FIGS. 1-7, core 820 comprises a stack of laminations. In one embodiment of the motor system 800, the core 820 is formed of silicon iron. Other embodiments include cores formed of ferromagnetic materials known to those in the motor arts. In one embodiment, modules 831 and 832 each include a bobbin 899 that is formed of a nonconductive material, as discussed below. Alternative embodiments, however, do not include a bobbin. Both modules 831, 832 further includes a wire coil 840 comprising at least one winding positioned around core 820. In one embodiment, the wire coil 840 can include about 100 windings.

In one embodiment, core 820 is substantially C-shaped. In an embodiment in which the core 820 comprises laminations, the laminations are referred to herein as “C-core laminations”. Each core 820 includes a pair of legs 893, 894 that extend from a center section 895 in the direction of the rotor 810 when the motor system 800 is assembled. Each leg 893, 894 comprises a plurality of teeth 815. Each tooth 815 includes an outer longitudinal flux surface 816. The surfaces 816 are separated from each other by corresponding grooves 817. The grooves 817 not only separate adjacent surfaces 816, but the shape of the grooves 817 also defines the shape of each tooth 815. In an embodiment comprising C-core laminations, when core laminations are secured together, core 820 includes rows of teeth 815 separated by rows of grooves 817. The core 820 in each module is fabricated using a ferromagnetic material that has a high saturation level at low current levels. In one embodiment, the material is silicon iron. Another suitable material is a cobalt-iron alloy, for example, HIPERCO® available from CARPENTER®.

In an embodiment in which core 820 comprises a stack of core laminations, adjacent stacked core laminations are fixed together to prevent their relative movement. Various methods for fixing the stacked laminations together include using a clamp, welding with a laser, staking or bonding with a non-conductive epoxy. Other methods for securing the laminations together can also be employed. In one embodiment, each stacked C-core lamination is bonded to an adjacent lamination by a non-conducting bonding epoxy that is applied by submerging each lamination of the stack in a bath of this epoxy in an impregnation fixture. In one embodiment, QT-30GF/000 from M. A. HANNA ENGINEERED MATERIALS is a sulfonated polysulfone polymer glass fiber reinforced material that is used as the insulating, non-conductive adhesive material. In another embodiment, EP19 HT-FL(SP) 8515 Flexiblize Mix, available from Master Bond® Polymer System, is an acceptable epoxy for securing adjacent laminations together.

In a method of securing the C-core laminations together in the stack by vacuum impregnation, the C-core laminations are stacked together in a conventional stacking fixture and covered with silicon caps. After the C-core laminations have been stacked together, their height is confined for accuracy. The C-core laminations are then submerged in a bonding epoxy (adhesive) within an impregnation fixture. The fixture cover is then closed and the vacuum turned on. The vacuum is maintained for about 20 minutes after the vacuum pressure level reaches about 25 inches of mercury. After approximately 20 minutes has expired, the C-core laminations are removed from the impregnation fixture and set in a dripping fixture. The adhesive is allowed to drip for about one hour. Any excess adhesive is cleaned from the stack and the bobbin is installed. The silicon caps are also removed and the C-cores are clamped in a curing fixture. The curing fixture is placed in an oven, pre-heated to about 300 degrees, then is ramped to about 375 degrees for about 1-hour and soaked at about 375 degrees for about 9hours. Cooling occurs in an oven at approximately 100 degrees. After the cooling has been completed, the C-core stack 201 is removed from the curing fixture and excess adhesive is removed.

The number of C-core laminations that are secured together to form the stack 201 can be varied in order to vary stack thickness. In one embodiment of the present invention, a module 831, 832 includes about twenty to about one hundred-twenty five secured laminations. One stack, according to an embodiment, includes about seventy secured C-core laminations. Each of these laminations is between about ten and twenty mils thick. A preferred thickness for each lamination is about fourteen mils. The greater the stack height, the more force produced by the modules 831 and 832.

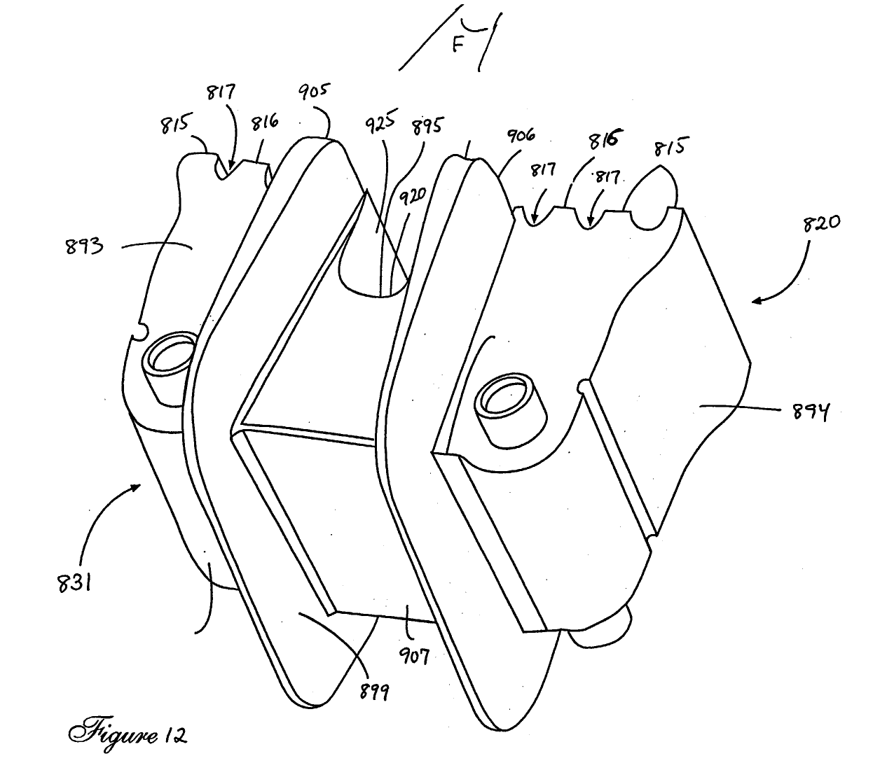

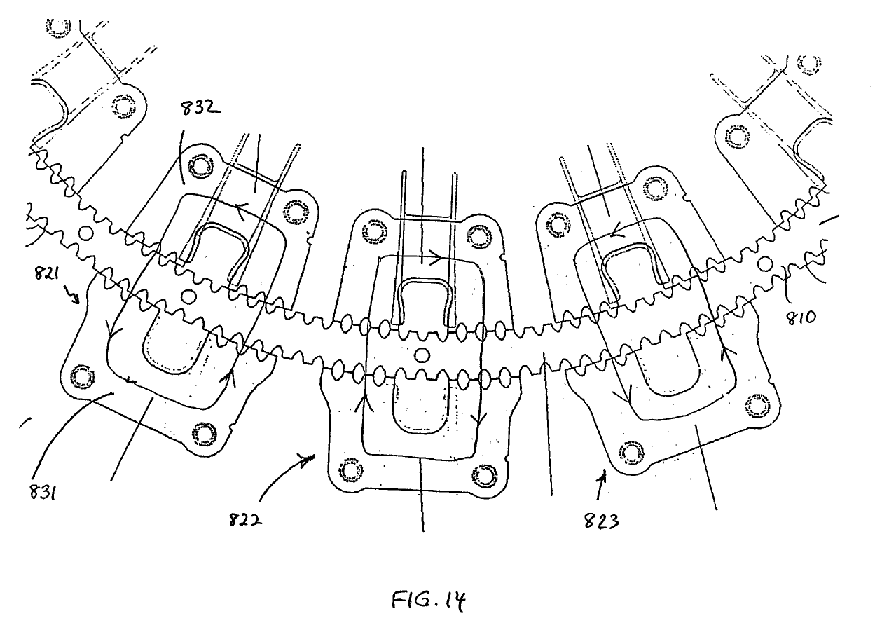

Wire coil 840 is formed by winding a wire at least one time, i.e., at least one turn, around the bobbin 899 at the center of module 831 and another wire 840 is wound around the bobbin 899 of module 832. Wire coil 840 is guided by the bobbin 899, which fits securely around the center 895 of core 820 as seen in FIG. 12. In one embodiment, the bobbin 899 includes grooves on its outer surface for receiving the coil 840. The wound coil 840 is positioned by bobbin 899 in a generally fan shape as discussed below. Other embodiments, however, include more coil layers yet still permit heat to be quickly dissipated. Additionally, by positioning the coil 840 between legs 893 and 894, the generated magnetic flux flows in the direction of the teeth 815 and is concentrated there. The modules of the preferred embodiment, as shown in the figures, are capable of being positioned closer together than the units of the prior art, thereby reducing the overall size of the motor system 800 compared to prior art motor systems. Similarly, the preferred embodiment permits more modules to be positioned in the same amount of space than does the prior art.

As illustrated in FIG. 12, each bobbin 899 has a substantially fan-like shape and is positioned about the center 895 of the core 820. The bobbins 899 of modules 831 and 832 both have an angled shape and include first and second sidewalls 905, 906, respectively spaced on opposite sides of a main body portion. The sidewalls 905, 906 of each module 831, 832 form an angle F, shown in FIG. 12, that allow the coil 840 to spread out when the coil 840 it is constrained by the bobbin 899. In a first embodiment of both modules, the angle F, created by the sidewalls 905 and 906, is between about 0 and 80 degrees. In another embodiment of the module 831, the angle is about 15 degrees. In another embodiment of the module 832, the angle is about 5 degrees. The outer surface of the bobbin 899 extends between sidewalls 905 and 906 and is received in a recess 915 that extends along a surface of core 820. A rotor facing surface 920 of the bobbin 899 is received in an opening 925 and positioned between the legs 893, 894 of the C-core 820. As seen in FIG. 12, the first and second sidewalls 905, 906 are spaced apart by a greater distance along the outer surface 907 of the bobbin 899 than along the rotor facing surface 920. This results in the bobbin 899 having a greater amount of surface area for receiving and spacing the coil 840 along the outer surface 907 than along the rotor facing surface 920. As a result, less overlap of the coil 840 will be present along the outer surface 907 than along the rotor facing surface 920. In one embodiment, each sidewall 905, 906 increases in height as it extends in the direction of the rotor 810 in order to provide support and guidance to the overlapping portions of the coil 840 at the rotor facing surface 920 while the coil 840 is being wrapped during the construction of the motor 800. Moreover, in an embodiment, each sidewall 905, 906 includes a hook member for anchoring the bobbin 899. Alternatively, the bobbin 899 is secured together and to the core 820 using well known adhesives.

The substantially fan-like shape of bobbin 899 and the resulting distribution pattern of the coil 840 are advantageous in directing the flow of magnetic flux through the legs 893 and 894 of the module 831, 832 and toward the teeth 815. The shape also provides better spatial distribution of the individual windings of the coil 840 compared to the prior art by spreading the coil windings over the largest possible surface area so that the number of winding layers is minimal. For example, in one embodiment of the invention, the fan shape results in the formation of only a few, e.g., one or two, layers of windings on an outer surface 907 of the bobbin 899. The individual windings wrapped around bobbin 899 are spread out over surface 907 so that there are fewer winding layers than found with prior art motors. By providing fewer winding layers, especially along surface 907, the preferred embodiment provides for a more efficient dissipation of the heat generated by electrical current flowing through coil 840. Thus, ambient air cooling is often sufficient for cooling motor system 800, and the need for forced air cooling systems is obviated. Of course, in alternative embodiments, other suitable arrangements are employed for winding the coil wire in a fan shaped manner.

The bobbin 899 is formed of a conventional electrically insulating material. In one embodiment, the bobbin 899 is made of two pieces formed of non-ferromagnetic and nonconductive materials such as plastics. In another embodiment, the material used to form the bobbin 899 includes liquid crystal polymers. No matter the material used, the bobbin 899 in one embodiment includes two pieces that are formed separate of the core 820, positioned over the core 820 and secured together to form the single, unitary bobbin during the assembly of the motor. In another embodiment, the unitary bobbin 899 is molded directly on and over the core 820 as a single piece. Additionally, in another embodiment, known electrically insulating materials are positioned between the coil 840 and the core 820 in place of the bobbin 899.

As illustrated in FIG. 10, the rotor 810, like the core 820, is formed from a plurality of plates (laminations) 450 fixed together to prevent relative movement of the rotor plates 450 and to ensure structural integrity. The rotor 810 can be formed in accordance with conventional practice and of the same material as the core laminations.

As seen in FIG. 8, the spacing between the modules 831, 832 and the rotor 810 creates air gaps. The size of the air gap on one side of the rotor 810 is preferably the same as on the other side of the rotor 810. In other words, the rotor 810 is preferably centered substantially exactly between opposing modules 831, 832 of a phase unit 821-823, as discussed above.

The amount of magnetomotive force generated by motor 800 is adjustable in several ways. A first way includes increasing or decreasing the number of laminations in core 820. A second way includes adjusting the number of windings of the coil 840 about the core 820. A third way includes adjusting the amount of current through the wire coil 840. Fourth and fifth ways include adjusting the number of modules per phase unit and the number of phase units in the motor 800, respectively. Any combination of these ways can also be used to adjust the force of the motor system 800.

Referring now to the exemplary embodiment shown in FIG. 14, magnetic flux flows in only one direction (i.e., either clockwise or counterclockwise) within a given phase unit in conjunction with rotor 810. As discussed above, the adjacent phase units are electrically and magnetically isolated and uncoupled from each other along each side of the rotor 810.

The electrical current through coil 840 of any given module 831, 832 may at any given position be adjusted such as by being turned on or off. By maintaining a constant magnetic flux direction within a module 831, 832, the modular phase variable reluctance motor system 800 reduces hysteresis losses in the rotor 810 that would be caused by reversing magnetic flux direction.

Hysteresis losses are proportional to the frequency of directional change of the magnetic flux. Therefore, in one embodiment of the invention, the flux direction in adjacent phase units 821-823 is alternated. For example, as shown in FIG. 14, the flux for phase unit 821 is in a counter-clockwise direction, the flux for phase unit 822 is in a clockwise direction, and the flux for phase unit 823 is in a counter-clockwise direction. In another embodiment, the flux for phase unit 821 is in a clockwise direction, the flux for phase unit 822 is in a counter-clockwise direction and the flux for phase unit 823 is in a clockwise direction.

Members 165 extend between adjacent phase units 821-823. A well-known adhesive, including those discussed above, are located between the shafts 882, 883 and their core 820 so that each core 820 is isolated from shafts 882, 883 and members 165 so that no flux leaks along the shafts and the members 850 between adjacent modules 831, 832.

As used herein, ferromagnetic material means any material possessing or exhibiting ferromagnetic properties, as that term is commonly understood, sufficient to make the material suitable for use in the present invention as described herein.

While the above description contains many specifics, these should not be construed as limitations on the scope of the invention, but rather as an exemplification of one preferred embodiment thereof. Other variations are possible.

What is claimed is:

1. A variable reluctance motor comprising:
a phase assembly comprising more than one phase unit, each of said phase units comprising at least one module, each said module comprising an electrically conductive coil wound around the module in one or more windings, each of said phase units being magnetically isolated from every other phase unit, each of said phase units defining a flux path; and
a ferromagnetic core within said flux path.

2. The motor of claim 1, wherein each said module comprises a core having two legs and a center portion, and an electrically conductive coil wound around the center portion.

3. The motor of claim 2, wherein each of the legs has a plurality of teeth facing the ferromagnetic core and the ferromagnetic core has a plurality of teeth facing the teeth of the modules.

4. The motor of claim 2, further comprising a controller for supplying electric current through said coils and thereby selectively inducing magnetic flux flow in opposite directions in adjacent phase units.

5. The motor of claim 1, wherein each of said coils includes a plurality of windings in the shape of a fan providing better spatial distribution between individual windings of the coil as individual windings extend away from the ferromagnetic core.

6. The motor of claim 1, wherein the motor is a linear motor and each phase unit has two modules, one on each side of the ferromagnetic core.

7. The motor of claim 1, wherein the motor is a rotary motor and each phase unit has two modules, one on each side of the ferromagnetic core.

8. The motor of claim 1, wherein the phase assembly comprises a plurality of substantially identical phase units, wherein the number of phase units is selected in accordance with a power requirement of the motor.

9. A variable reluctance motor, comprising a plurality of phase units and a ferromagnetic core, each of the phase units comprises a C-shaped core having two legs and a center portion, a coil around the center portion, and a plurality of teeth at the ends of the legs, wherein the teeth face the ferromagnetic core and each of the phase units are substantially magnetically isolated from each other.

10. The motor of claim 9, wherein the ferromagnetic core includes a plurality of teeth facing the teeth of the C-shaped core.

11. The motor of claim 9, wherein each of the phase units defines a flux path, and the ferromagnetic core is within the flux paths.

12. The motor of claim 9, wherein the motor is a linear motor and the ferromagnetic core is a stator along which the phase units move.

13. The motor of claim 11, wherein the motor is a rotary motor and the ferromagnetic core rotates about the phase units.

14. A method of controlling a variable reluctance motor having at least first and second adjacent phase units, wherein the first phase unit includes at least one leg through which a first magnetic flux passes during operation of the motor and the second phase unit includes at least one leg through which a second magnetic flux passes during operation of the motor, and the at least one leg of the first phase unit is adjacent to the at least one leg of the second phase unit, the method comprising:
supplying electric current to a first electrically conductive coil in the first phase unit of the motor and thereby inducing an electromagnetic flux in the first phase unit in a first direction; and
supplying electric current to a second electrically conductive coil in the second phase unit of the motor and thereby inducing an electromagnetic flux in the second phase unit in a second direction;
said phase units being arranged such that the magnetic flux passes through the leg of the first phase unit in a same direction as the magnetic flux passes through the adjacent leg of the second phase unit.

15. The method of claim 14, wherein the motor is a linear motor and the electric currents cause the phase units to move with respect to a stator.

16. The method of claim 14, wherein the motor is a rotary motor and the electric currents cause a ferromagnetic core to revolve with respect to the phase units.

17. A module for a variable reluctance motor, the module comprising:
a C-shaped core having a center portion and two legs extending away from the center portion in a first direction; and
a fan shaped guide in the center portion for a plurality of windings, the guide having a first section facing the first direction and a second section facing away from the first direction, the first section being narrower than the second section so that the windings in the first section are closer together than the windings in the second section.

18. The module of claim 17, wherein the variable reluctance motor is a rotary motor and the first section faces a ferromagnetic core.

19. The module of claim 17, wherein the variable reluctance motor is a linear motor and the first section faces a stator.

20. The module of claim 17, wherein the fan shaped guide includes a bobbin made from nonconductive and nonferrous material.
